(19) United States
(12) Patent Application Publication
(10) Pub. No.: US 2016/0338439 A1
(43) Pub. Date: Nov. 24, 2016

(54) HMD Mount

(71) Applicant: Jeffrey Walden, El Paso, TX (US)

(72) Inventor: Jeffrey Walden, El Paso, TX (US)

(21) Appl. No.: 14/663,369

(22) Filed: May 20, 2015

(51) Int. Cl. A42B 3/04; A42B 3/12; A42B 3/30; G02B 27/01

(52) U.S. Cl. CPC A42B 3/0406; G02B 27/0176; A42B 3/12; A42B 3/30

(57) ABSTRACT

The present invention provides a helmet adapted to receive a user's head therein and further adapted to hold a head mounted display (HMD) thereon. The helmet has a hinged faceplate that can substantially cover the user's face and extends downward around the user's chin. The faceplate is adapted to receive a microphone input, and a headphone connection may also be provided. The faceplate is able to accommodate a pair of virtual reality goggles or other HMD thereon. The helmet is weighted so that there is an even weight distribution across the helmet. In this way, the helmet is balanced and comfortable to wear. Additionally, the design on the exterior surfaces of the helmet can be customized to suit the user's preferences.

### BACKGROUND

A head mounted display, also known as a helmet mounted display, is a display device that can be worn on a user's head or as part of a helmet. Such devices are commonly used to play video games and provide users with a heightened sense of immersion relative to traditional video game devices. Conventional HMDs cover the eyes and provide the minimum attachment means necessary to hold the HMD in place on the user's face. Conventional HMDs are also weighted towards the front of the user's head because the HMD is situated on the user's face. This may be uncomfortable for the user and may cause the HMD to shift on the user's face while in use. Further, conventional HMDs do not help to block out distractions in the surrounding environment and such distractions may detrimentally affect the user's experience. Conventional HMDs may also be difficult to place and remove quickly, particularly when the user must place or remove a microphone and headphones.

Devices are known in the prior art that relate to helmets having visual and audio devices incorporated therein. Some patents describe a virtual reality helmet that comprises a visor opening sized for reception of virtual reality goggles therein, and further comprising a means for delivering audio to an individual. Other patents disclose a helmet mounted display which can be removed from the helmet. These devices, however, do not provide a helmet that comprises a hingedly attached faceplate that extends around a user's chin, and the prior art devices further do not provide helmets that have a balanced weight distribution.

### BRIEF DESCRIPTION OF FIGURES

FIG. 1 shows a view of various embodiments of the helmet of the present invention.

FIG. 2 shows a view of the hinged faceplate of the present invention.

FIG. 3 shows a view of a user wearing the helmet of the present invention and a pair of goggles.

FIG. 4 shows a view of the various components of the helmet of the present invention.

FIG. 5 shows a view of an embodiment of the helmet of the present invention.

### DESCRIPTION OF INVENTION

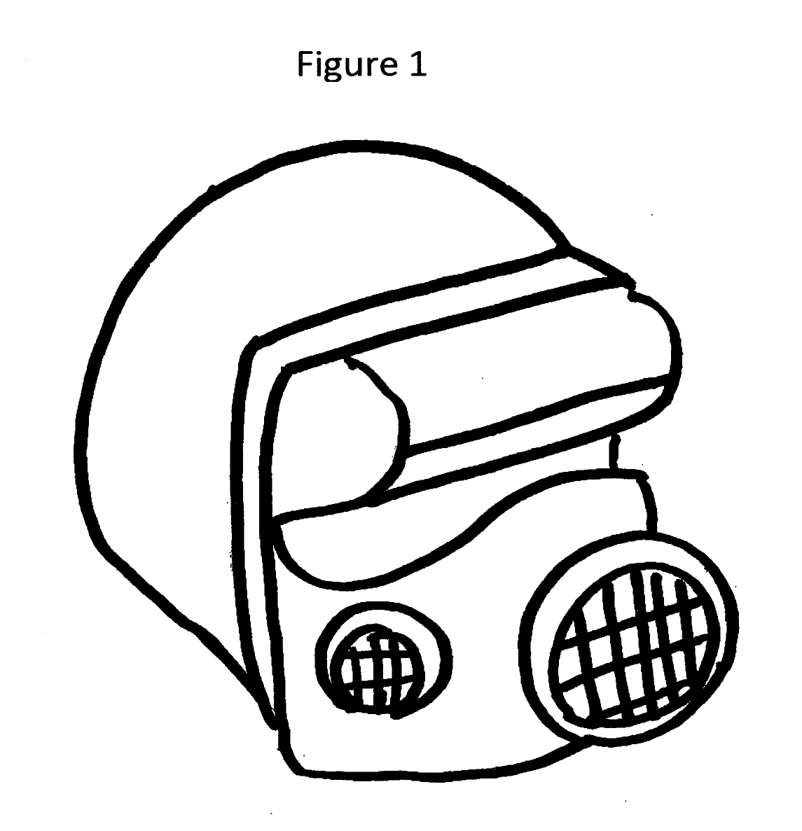

Referring now to FIG. 1, there is shown a view of various embodiments of the helmet of the present invention. The present invention provides a helmet adapted to support a HMD. The helmet comprises a shell having an interior volume, wherein the helmet is adapted to be secured on a users head. The shell covers the back, sides and top of the user's head, but does not cover the user's face. The shell is composed of a rigid material such as a hard plastic, or other suitable material. Further, the interior of the shell may have a soft or cushioned lining thereon to improve comfort for the user. The helmet further comprises a faceplate that is hingedly attached to the front of the helmet and that is adapted to receive a HMD or goggles thereon. The helmet and faceplate have means for receiving a microphone and a pair of headphones therein.

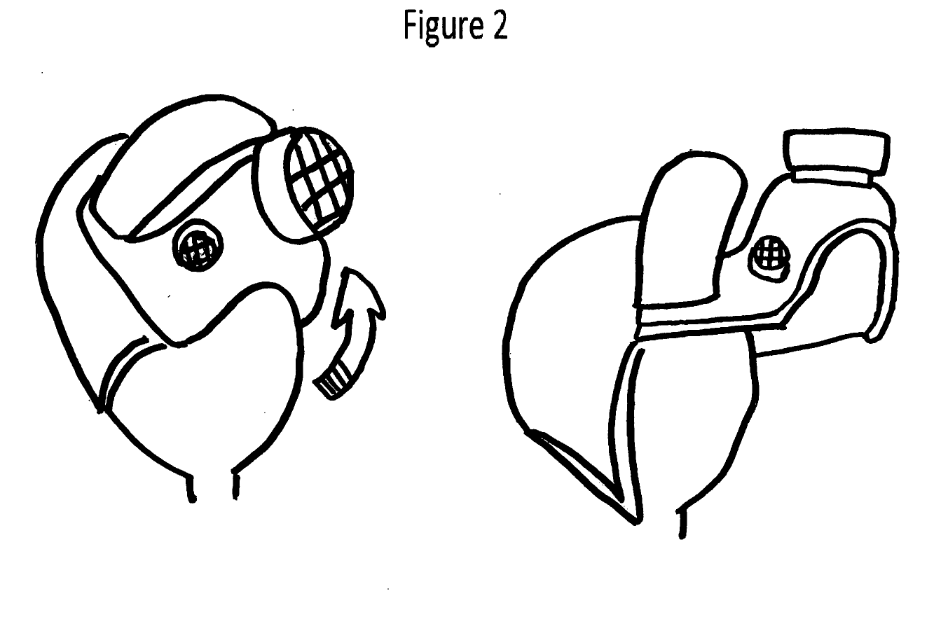

Referring now to FIG. 2, there is shown a view of the hinged faceplate of the present invention. The faceplate can be oriented in a closed configuration in which it substantially covers the user's face and extends around the user's chin. The faceplate has an opening in which any of a variety of HMDs can be mounted. The faceplate can be pivoted about the hinge in an open configuration to expose the wearer's face, without requiring the user to remove the HMD from the faceplate. The faceplate and helmet help to block out distractions to improve the user's immersion, focus, and overall experience.

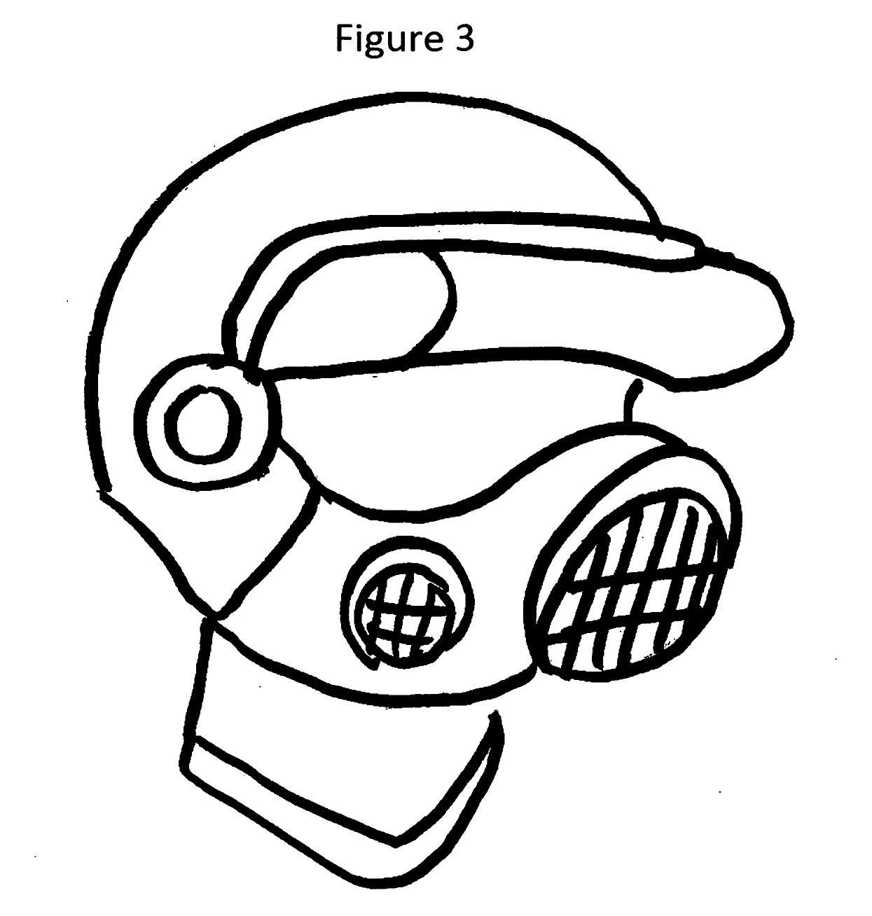

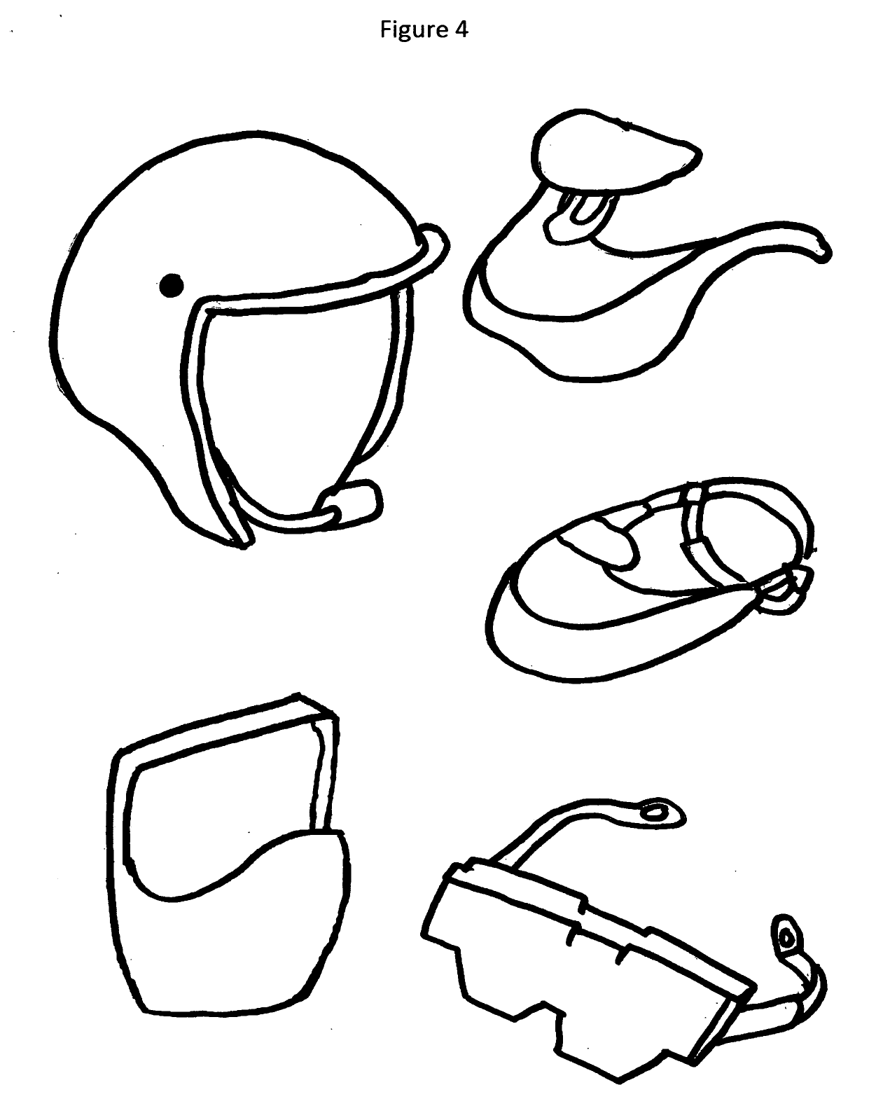

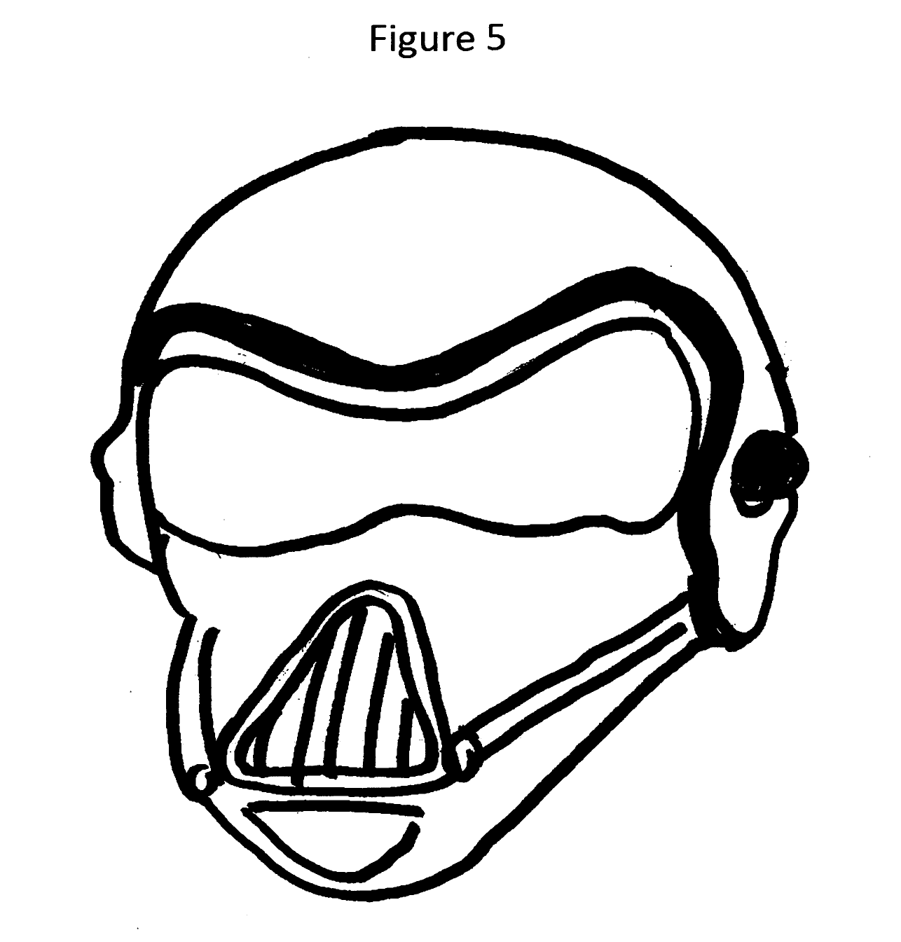

Referring now to FIGS. 3 through 5, there are shown various views of the helmet of the present invention and the components thereof. The helmet of the present invention may include an integrated microphone and headphones, or may be adapted to receive a microphone and headphones therein. The helmet is weighted so that there is an even weight distribution on the user's head for added comfort. The helmet and faceplate may have any of a variety of designs thereon as desired by the user. For example, the faceplate may resemble a gas mask, or the helmet may resemble a storm trooper helmet.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

The embodiments of the invention in which an exclusive property or privilege is claimed are defined as follows:

1. A helmet comprising a shell having an interior volume, wherein the aforementioned helmet is adapted to be secured on a user's head.

2. The helmet of claim 1, consists of a shell covering the back, sides and top of the user's head, but does not cover the user's face.

3. The helmet of claim 1, of which consists of the exterior and interior surfaces of the aforementioned shell and additional components that can be customized to suit the user's preferences.

4. The helmet of claim 1, of which consists of a rigid material such as a hard plastic, or other suitable material.

5. The helmet of claim 1, wherein the interior shell and additional components may consist of a soft or cushioned lining thereon to improve comfort for the user.

6. The helmet of claim 1, further includes the means for receiving a microphone and a pair of headphones therein.

7. The helmet of claim 1, which includes a balanced weight distribution while in use with attachments in place.

8. The aforementioned helmet further comprises a faceplate that is hingedly attached to the aforementioned helmet and that is adapted to receive a HMD or similar device thereon.

9. The faceplate of claim 8, wherein consists an opening in which any of a variety of HMDs or similar devices can be mounted.

10. The faceplate of claim 8, comprises a hinge or pivot mounted to the aforementioned helmet that can move to an open configuration to expose the wearer's face during use, without requiring the user to remove the HMD from the faceplate.

11. The faceplate of claim 8, comprises a hinge or pivot that includes an orientation in a closed configuration in which it substantially covers the user's face during use while allowing use of HMD or similar devices.

12. The faceplate of claim 8, of which consists of a rigid material such as a hard plastic, or other suitable material.
